(19) United States
(12) Patent Application Publication
(10) Pub. No.: US 2025/0109555 A1
(43) Pub. Date: Apr. 3, 2025

(54) Transport Facility

(71) Applicant: Daifuku Co., Ltd., Osaka-shi (JP)

(72) Inventors: Takafumi Yamazaki, Hinocho (JP); Kouichi Iida, Hinocho (JP)

(21) Appl. No.: 18/899,767

(22) Filed: Sep. 27, 2024

(30) Foreign Application Priority Data
Sep. 29, 2023 (JP) 2023-169639

(51) Int. Cl. E01B 11/42; B61B 3/02; B61L 23/04; E01B 25/22

(52) U.S. Cl. CPC E01B 11/42; B61B 3/02; B61L 23/041; E01B 25/22

(57) ABSTRACT

A transportation facility includes a rail extending through an opening, a door to open and close the opening, and a restrictor. The rail includes a movable rail, a first fixed rail, and a second fixed rail. The movable rail is shiftable between a connected orientation in which the movable rail is disposed in the overlapping area to connect the first fixed rail to the second fixed rail, and a retracted orientation in which the movable rail is disposed outside of the overlapping area to disconnect the first fixed rail from the second fixed rail. The restrictor is in a normal orientation with the movable rail in the connected orientation where the restrictor does not restrict travel of a transport vehicle, and shifts to a protruding orientation in response to the movable rail being shifted from the connected orientation to the retracted orientation where the restrictor restricts travel of the transport vehicle.

### CROSS-REFERENCE TO RELATED APPLICATION

This application claims priority to Japanese Patent Application No. 2023-169639 filed Sep. 29, 2023, the disclosure of which is hereby incorporated by reference in its entirety.

### BACKGROUND OF THE INVENTION

### Field of the Invention

The present invention relates to a transport facility including rails disposed along a travel path of transport vehicles extending through an opening in a wall and a door to open and close the opening.

### Description of Related Art

An example of such a transport facility is described in Japanese Unexamined Patent Application Publication No. 2019-59596. In the background described hereafter, reference signs and names in parentheses are the reference signs and the names in Japanese Unexamined Patent Application Publication No. 2019-59596.

A transport facility described in Japanese Unexamined Patent Application Publication No. 2019-59596 includes an article transport vehicle (1) that travels along a travel path (L) extending through an opening (3) in a wall (2), guide rails (4) for guiding the article transport vehicle (1) along the travel path (L), and a fire door (7) that moves along the wall surface of the wall (2) to close the opening (3). The guide rails (4) have a first gap (G1) to allow the fire door (7) to pass through. The guide rails (4) include first rail bodies (41) and second rail bodies (42) disposed opposite to each other in the direction along the travel path (L) with a second gap (G2) larger than the first gap (G1) between the first rail bodies (41) and second rail bodies (42). The guide rails (4) further include first adjusters (8) attached to the first rail bodies (41) and second adjusters (9) attached to the second rail bodies (42). The first rail bodies (41) each include a first body travel surface (41a) on which a travel wheel (16) of the article transport vehicle (1) rolls. The second rail bodies (42) each include a second body travel surface (42a) on which another travel wheel (16) of the article transport vehicle (1) rolls. The first adjusters (8) each include a first adjusting travel surface (8a) continuous with the first body travel surface (41a). The first adjusting travel surface (8a) at least partially protrudes into the second gap (G2). The second adjusters (9) each include a second adjusting travel surface (9a) continuous with the second body travel surface (42a). The second adjusting travel surface (9a) at least partially protrudes into the second gap (G2). The first adjusters (8) and the second adjusters (9) face each other with the first gap (G1) between them. An adjusting assembly (MA) is included to allow the position of the first gap (G1) to be changeable in the direction along the travel path (L).

The transport facility described in Japanese Unexamined Patent Application Publication No. 2019-59596 has the first gap (G1) constantly between the guide rails (4) to allow the fire door (7) to pass through. The article transport vehicle (1) traveling at high speed can often have large vibrations when passing through the first gap (G1). The article transport vehicle (1) may thus have a lower travel speed to reduce such vibrations. However, this reduces the transport efficiency of articles with the article transport vehicle (1).

### SUMMARY OF THE INVENTION

One or more aspects are directed to a transport facility that reduces vibrations in a transport vehicle passing an overlapping area in which a door path that is a movement path of the door overlaps the travel path along the rails.

A technique responding to the above issue provides the structure described below. A transport facility includes a rail, a door, and a restrictor. The rail is a rail on which a transport vehicle travels, the rail extending along a travel path of the transport vehicle in a path direction through an opening in a wall. The door opens and closes the opening. The rail includes a movable rail, a first fixed rail, and a second fixed rail. The movable rail is disposed in an overlapping area overlapping a door path that is a movement path of the door in opening and closing the opening. The first fixed rail is disposed on a first side in a path direction relative to the overlapping area. The second fixed rail is disposed on a second side in the path direction relative to the overlapping area. The first side and the second side in the path direction are opposite sides in the path direction. The movable rail is shiftable between a connected orientation, in which the movable rail is disposed in the overlapping area to connect the first fixed rail to the second fixed rail, and a retracted orientation, in which the movable rail is disposed outside of the overlapping area to disconnect the first fixed rail from the second fixed rail. The restrictor is to be in a normal orientation with the movable rail in the connected orientation, in which normal orientation the restrictor does not overlap with a transport vehicle path that is a movement path of the transport vehicle. The restrictor is to shift to a protruding orientation in response to the movable rail being shifted from the connected orientation to the retracted orientation, in which protruding orientation the restrictor protrudes to a position overlapping the transport vehicle path to restrict travel of the transport vehicle.

In this structure with the above aspect, the movable rail is shiftable from the connected orientation to the retracted orientation to prevent the rail from obstructing the opening or closing operation of the door. When the movable rail is in the connected orientation, the first fixed rail and the second fixed rail are connected by the movable rail. This reduces steps and gaps between the rails in the overlapping area, and thus reduces vibrations in the transport vehicle passing through the overlapping area.

The structure includes the restrictor that protrudes to the position overlapping the transport vehicle path in response to the movable rail shifting to the retracted orientation and restricts the travel of the transport vehicle. The structure thus appropriately restricts the transport vehicle from entering a disconnected section when the first fixed rail and the second fixed rail are disconnected by the movable rail.

In this structure, the restrictor shifts to the protruding orientation in response to the movable rail shifting from the connected orientation to the retracted orientation. Thus, a dedicated drive source for shifting the restrictor orientation is less likely to be used. The structure of the restrictor can thus be simplified easily to reduce costs.

Further features and advantageous effects of the technique according to one or more embodiments of the disclosure will be apparent from exemplary and nonlimiting embodiments described below with reference to the drawings.

### BRIEF DESCRIPTION OF THE DRAWINGS

FIG. 1 is a plan view of a transport facility showing its main components.

FIG. 2 is a side view of the transport facility showing a movable rail in a connected orientation.

FIG. 3 is a side view of the transport facility showing the movable rail during an orientation shift.

FIG. 4 is a side view of the transport facility showing the movable rail during the orientation shift.

FIG. 5 is a side view of the transport facility showing the movable rail in a retracted orientation.

FIG. 6 is a side view of a transport vehicle being restricted from traveling by first restrictors.

FIG. 7 is a cross-sectional view taken along line VII-VII in FIG. 6 when viewed in the direction indicated by the arrows.

FIG. 8 is a perspective view of the first restrictors in a protruding orientation.

FIG. 9 is a side view of the transport vehicle being restricted from traveling by second restrictors.

FIG. 10 is a cross-sectional view taken along line X-X in FIG. 9 when viewed in the direction indicated by the arrows.

FIG. 11 is a perspective view of the second restrictors in a protruding orientation.

FIG. 12 is a control block diagram of the transport facility.

FIG. 13 is a schematic diagram of sensors on the movable rail.

### DESCRIPTION OF THE INVENTION

### 1. Embodiment

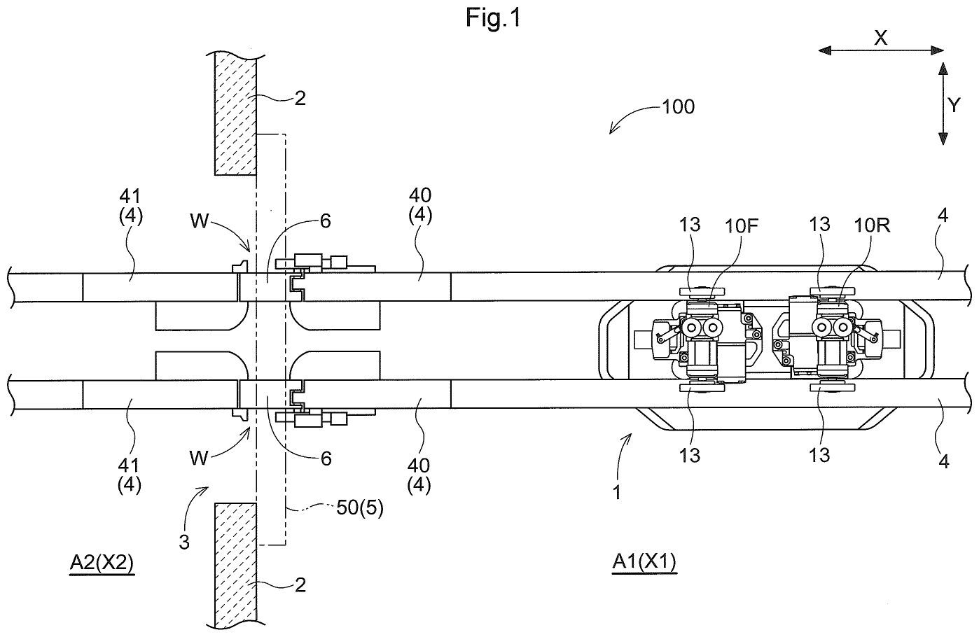

A transport facility 100 according to one or more embodiments will be described with reference to the drawings. As shown in FIG. 1, the transport facility 100 includes rails 4 disposed along a travel path of a transport vehicle 1 extending through an opening 3 in a wall 2 and a door 5 to open and close the opening 3. The door 5 in the present embodiment is a fire door. However, the door is not limited to the fire door and may be, for example, an air shutoff door.

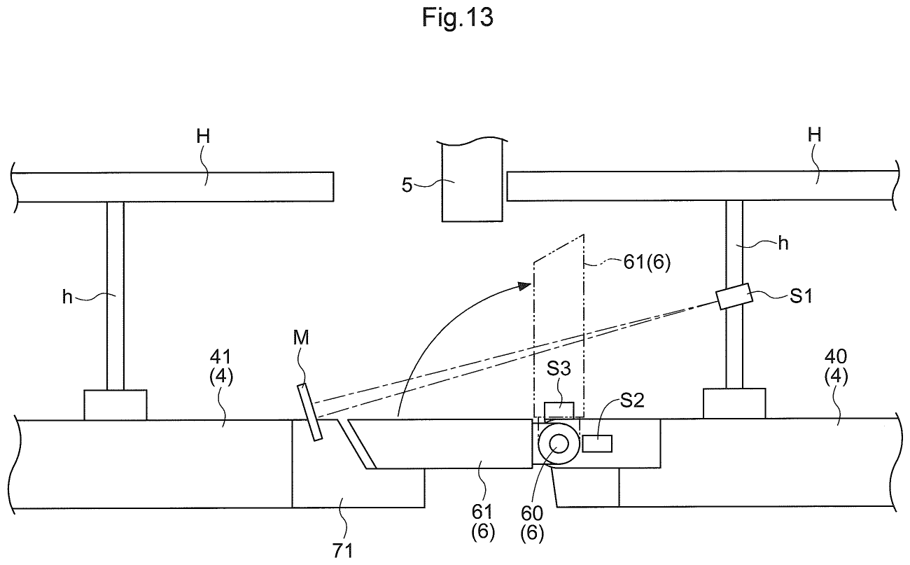

The transport vehicle 1 includes travelers 10, a body 11, and connectors 12. The travelers 10 travel along the rails 4 on the upper surfaces of the rails 4 hung from a ceiling H (refer to FIG. 13) with hanging members h. The body 11 is hung from and supported by the travelers 10 and travels below the rails 4. The connectors 12 connect the travelers 10 and the body 11.

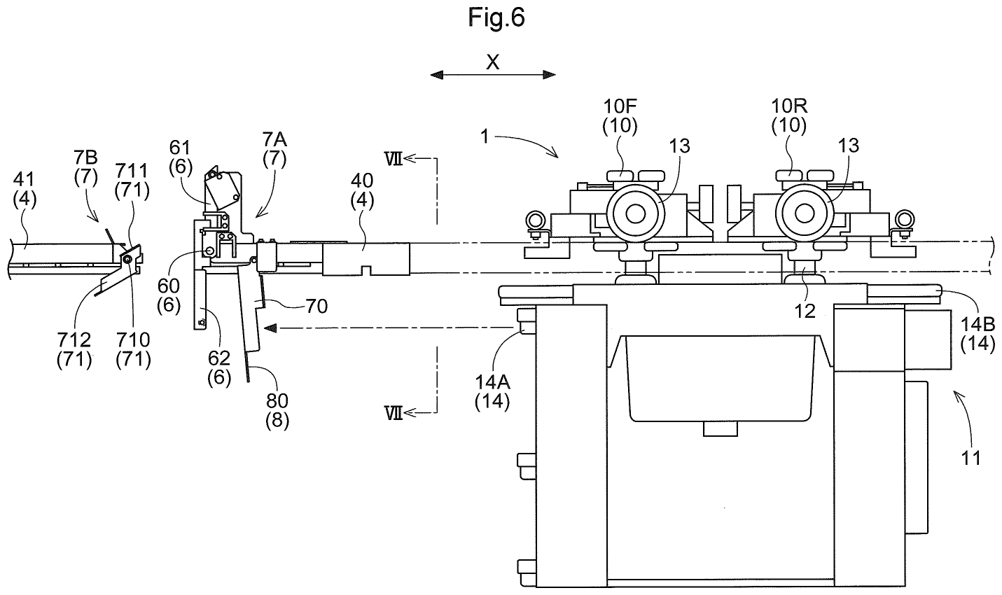

The travelers 10 include a front traveler 10F and a rear traveler 10R aligned in the front-rear direction of the vehicle body. A pair of front and rear connectors 12 are connected to the body 11 each in a manner rotatable about a vertical axis. Each of the front traveler 10F and the rear traveler 10R is rotatable together with the corresponding connector 12 about the vertical axis. The pair of front and rear connectors 12 (refer to FIG. 6) is disposed between a pair of left and right rails 4.

The front traveler 10F includes a pair of left and right travel wheels 13 driven by an electric drive motor to rotate. Each travel wheel 13 rolls on the upper surface of the corresponding one of the pair of left and right rails 4 to travel. The front traveler 10F includes two pairs of left and right guide wheels that each freely rotate about an axis extending in the vertical direction. Each guide wheel is in contact with the inner side surface of the corresponding one of the pair of left and right rails 4.

The rear traveler 10R includes, similarly to the front traveler 10F, a pair of left and right travel wheels 13 and two pairs of left and right guide wheels. As described above, the transport vehicle 1 includes the pair of left and right travel wheels 13. The pair of left and right rails 4 each include a travel surface on which the travel wheels 13 of the transport vehicle 1 roll.

The body 11 includes sensors 14 (refer to FIG. 6) on two side surfaces facing in travel directions to detect restrictors 7 described later. Examples of the sensors 14 include an obstacle sensor 14A and a collision sensor 14B. In the present embodiment, the obstacle sensor 14A is disposed on a surface of the transport vehicle 1 facing in a forward travel direction, and the collision sensor 14B is disposed on a surface of the transport vehicle 1 facing in a backward travel direction. The obstacle sensor 14A may be, for example, an optical sensor. The collision sensor 14B may be, for example, a bumper switch.

With the guide wheels of the front and rear travelers 10F and 10R guided along the pair of left and right rails 4 to restrict the position of the transport vehicle 1 in a body width direction Y, the travel wheels 13 of the front and rear travelers 10F and 10R are driven to rotate. The transport vehicle 1 thus travels along the rails 4.

As shown in FIG. 1, the transport facility 100 with this structure is disposed across a first area A1 and a second area A2. In the present embodiment, the first area A1 and the second area A2 are both defined in a clean room.

At the boundary between the first area A1 and the second area A2, the wall 2 including the opening 3 through which the travel path of the transport vehicle 1 extends is disposed. The wall 2 divides the first area A1 and the second area A2. The door 5 to open and close the opening 3 is also disposed at the boundary. The door 5 is movable along a surface of the wall 2 between a closed position to close the opening 3 and an open position to open the opening 3. In the present embodiment, the door 5 is vertically movable along the surface of the wall 2. In some embodiments, the door 5 may be movable in the lateral direction (horizontal direction) along the surface of the wall 2. As described above, the transport facility 100 includes the door 5 that is movable along the surface of the wall 2 to close the opening 3.

The direction along the travel path is defined as a path direction X. A first side in the path direction X is defined as a first side X1 in the path direction, and a second side in the path direction X is defined as a second side X2 in the path direction. In the present embodiment, the first area A1 is disposed on the first side X1 in the path direction, and the second area A2 is disposed on the second side X2 in the path direction. In the present embodiment, the forward travel direction of the transport vehicle 1 is defined as a direction from the first side X1 in the path direction toward the second side X2 in the path direction, and the backward travel direction of the transport vehicle 1 is defined as a direction from the second side X2 in the path direction toward the first side X1 in the path direction.

The rails 4 include movable rails 6 disposed in an overlapping area W overlapping a door path 50 that is the movement path of the door 5 in opening and closing the opening 3, first fixed rails 40 disposed on the first side X1 in the path direction relative to the overlapping area W, second fixed rails 41 disposed on the second side X2 in the path direction relative to the overlapping area W, and support members 71 that support ends of the movable rails 6. The positions of the first fixed rails 40 and the second fixed rails 41 are fixed relative to the opening 3.

In the present embodiment, the first fixed rails 40 are rail portions disposed in front of the overlapping area W in the forward travel direction of the transport vehicle 1. In some embodiments, the first fixed rails 40 may be rail portions disposed beyond the overlapping area W in the forward travel direction of the transport vehicle 1. Detecting the restrictors 7 from a predetermined distance using the obstacle sensor 14A (described later) allows the transport vehicle 1 to stop before reaching the overlapping area W.

In the present embodiment, the second fixed rails 41 are rail portions disposed beyond the overlapping area W in the forward travel direction of the transport vehicle 1. In some embodiments, the second fixed rails 41 may be rail portions disposed in front of the overlapping area W in the forward travel direction of the transport vehicle 1.

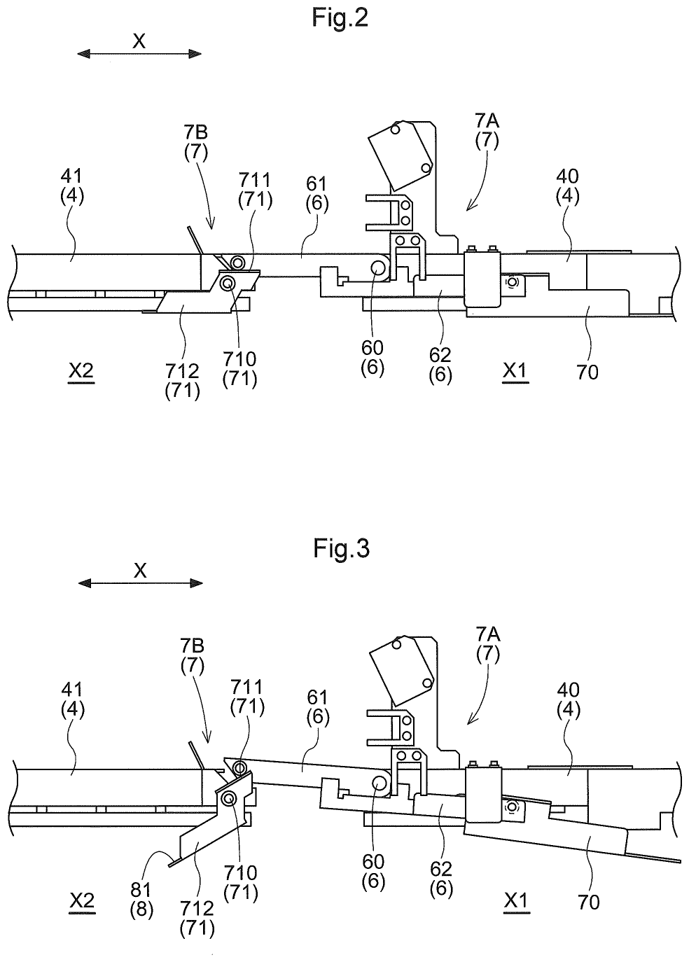

The movable rails 6 is shiftable between the connected orientation (refer to FIG. 2) and the retracted orientation (refer to FIG. 5). The movable rails 6 are disposed in the overlapping area W in the connected orientation to connect the first fixed rails 40 and the second fixed rails 41, and are disposed outside of the overlapping area W in the retracted orientation to disconnect the first fixed rails 40 and the second fixed rails 41. The movable rails 6 cover an area larger than the overlapping area W when viewed in the vertical direction.

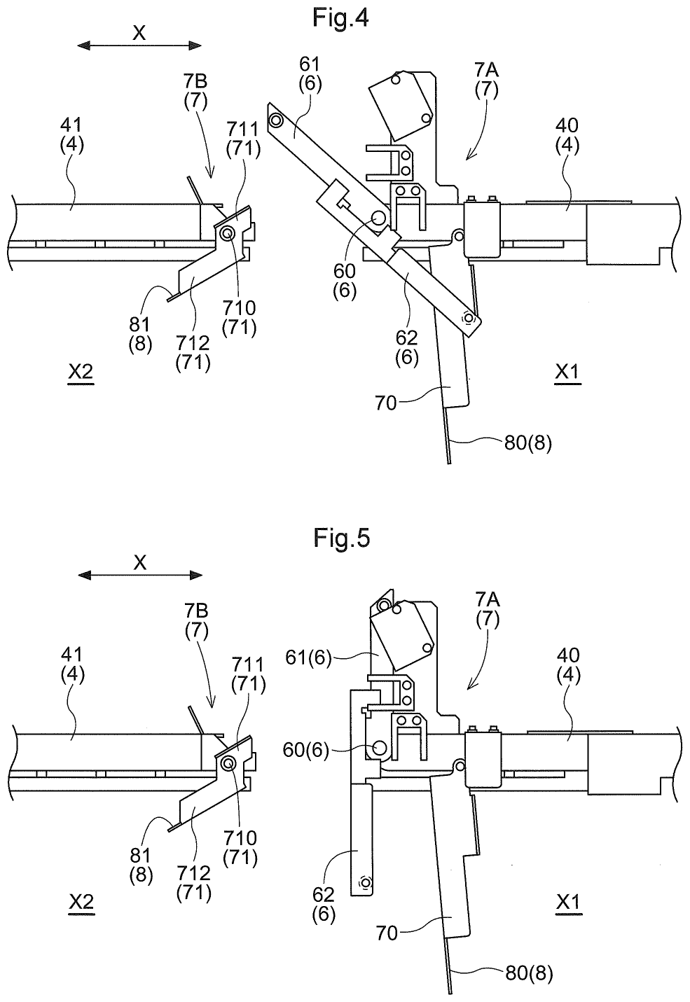

As shown in FIGS. 2 to 5, the movable rails 6 each include a first shaft support 60, a rail connector 61, and a first extension 62. The first shaft support 60 is supported on the corresponding first fixed rail 40 in a manner swingable about a first rotation axis extending in the width direction Y perpendicular to the path direction X when viewed in the vertical direction. The rail connector 61 is to be a connecting portion between the corresponding first fixed rail 40 and second fixed rail 41 in the connected orientation. The first extension 62 extends toward the first side X1 in the path direction relative to the first shaft support 60 in the connected orientation.

In response to the movable rails 6 shifting from the connected orientation to the retracted orientation, the rail connectors 61 swing upward about the first rotation axis relative to the first fixed rails 40 and the first extensions 62 swing downward about the first rotation axis relative to the first fixed rails 40.

The transport facility 100 also includes the restrictors 7 to restrict the travel of the transport vehicle 1. The restrictors 7 in the present embodiment include first restrictors 7A to restrict the forward travel of the transport vehicle 1, and second restrictors 7B to restrict the backward travel of the transport vehicle 1.

In the present embodiment, the first restrictors 7A are supported by the respective first fixed rails 40, and the second restrictors 7B are supported by the respective second fixed rails 41. The restrictors 7 are not limited to the above example, and may be supported by support structures that support the rails 4 or by the wall 2.

The first restrictors 7A each include a swing member 70 that swings downward in response to the first extension 62 in the corresponding movable rail 6 swinging downward.

The swing members 70 are supported on the respective first fixed rails 40 in a manner swingable about a rotation axis extending in the width direction Y at a position upstream from the movable rails 6 in the travel direction. When the movable rails 6 are in the connected orientation, the swing members 70 are supported by the respective first extensions 62 in the movable rails 6 to extend in a direction in which the first fixed rails 40 extend. When the movable rails 6 shift to the retracted orientation, the first extensions 62 swing downward and release the swing members 70, causing the swing members 70 to swing downward under their weight. The swing members 70 are not limited to the above example, and may be, for example, linked with the first extensions 62 to move together using a known linkage member, rather than under their weight.

The second restrictors 7B each include a support member 71. Although not illustrated, the second restrictors 7B may each further include, in addition to the support member 71, a swing member 70 that swings downward in response to the second extension 712 in the support member 71 swinging downward. In this case, the swing member 70 may be released in response to the second extension 712 swinging downward and swing downward under their weight. The swing member 70 may be linked with the second extension 712 to move together using a known a linkage member, rather than under their weight.

The support members 71 each include a second shaft support 710, a support 711, and a second extension 712. The second shaft support 710 is supported on the corresponding second fixed rail 41 in a manner swingable about a second rotation axis extending in the width direction Y. The support 711 supports, from below, an end of the corresponding rail connector 61 on the second side X2 in the path direction, with the movable rails 6 in the connected orientation. The second extension 712 extends toward the second side X2 in the path direction relative to the second shaft support 710 with the movable rails 6 in the connected orientation.

In response to the movable rails 6 shifting from the connected orientation to the retracted orientation, the rail connectors 61 swing upward about the first rotation axis relative to the first fixed rails 40 and the ends of the rail connectors 61 on the second side X2 in the path direction move away from the supports 711 to cause the support members 71 to swing about the second rotation axis to move the second extensions 712 downward relative to the second fixed rails 41.

When the movable rails 6 are in the connected orientation, the first restrictors 7A and the second restrictors 7B are in a normal orientation (refer to FIG. 2) in which the first restrictors 7A and the second restrictors 7B have no overlap with a transport vehicle path that is the movement path of the transport vehicle 1. In response to the movable rails 6 shifting from the connected orientation to the retracted orientation, the first restrictors 7A and the second restrictors 7B shift to a protruding orientation (refer to FIG. 5) in which the first restrictors 7A and the second restrictors 7B protrude to positions overlapping the transport vehicle path to restrict the travel of the transport vehicle 1. In the present embodiment, neither the first restrictors 7A nor the second restrictors 7B include an independent drive source, but each include a swing assembly using its weight that causes the first restrictors 7A or the second restrictors 7B to protrude in response to the movement of the movable rails 6. In place of a swinging assembly using weight, an assembly using an urging force from a spring may cause the first restrictors 7A or the second restrictors 7B to protrude.

The shift of the first restrictors 7A and the second restrictors 7B from the normal orientation to the protruding orientation may be caused by mechanical linkage with an orientation shift of the movable rails 6 instead of using any of the assemblies described above. In this case, a structure such as a linkage assembly, a gear assembly, or a cam assembly may be used to achieve such linkage. The first restrictors 7A and the second restrictors 7B may shift their positions using a common drive source shared with the movable rails 6.

In the present embodiment, the first restrictors 7A and the second restrictors 7B both shift from the protruding orientation to the normal orientation in response to the movable rails 6 shifting from the retracted orientation to the connected orientation. More specifically, when the movable rails 6 shift from the retracted orientation to the connected orientation, the first extensions 62 in the movable rails 6 push the respective swing members 70, causing the first restrictors 7A to shift from the protruding orientation to the normal orientation. When the movable rails 6 shift from the retracted orientation to the connected orientation, the rail connectors 61 in the movable rails 6 push the respective supports 711, causing the second restrictors 7B to shift from the protruding orientation to the normal orientation. The first restrictors 7A and the second restrictors 7B may be shifted from the protruding orientation to the normal orientation manually by, for example, an operator, rather than by a motion linked to the movable rails 6.

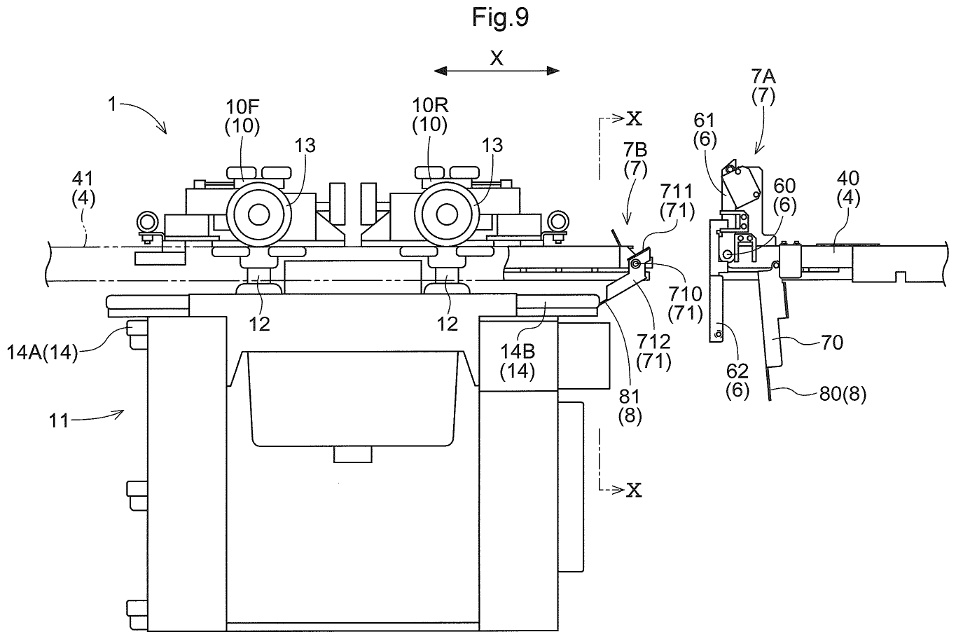

As shown in FIGS. 6 and 9, the restrictors 7 include detection targets 8 that serve as at least one of a part to be detectable by the obstacle sensor 14A included in the transport vehicle 1 or a part to be in contact with the collision sensor 14B included in the transport vehicle 1 in the protruding orientation. The restrictors 7 are not limited to the above example, and may include a member to forcibly restrict the travel of the transport vehicle 1 by contacting, for example, a wheel or the body of the transport vehicle 1 rather than being detectable by the sensors 14 in the transport vehicle 1.

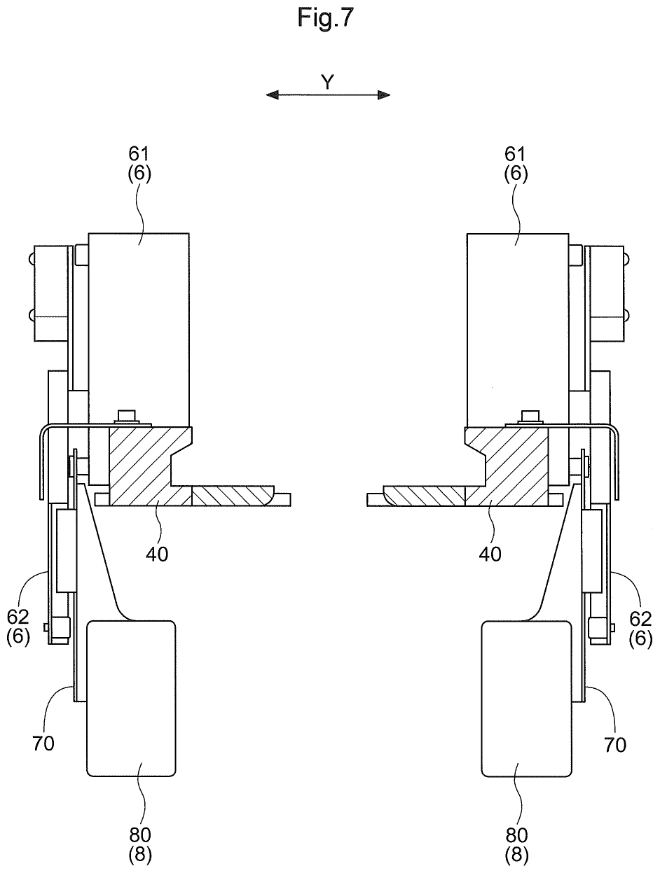

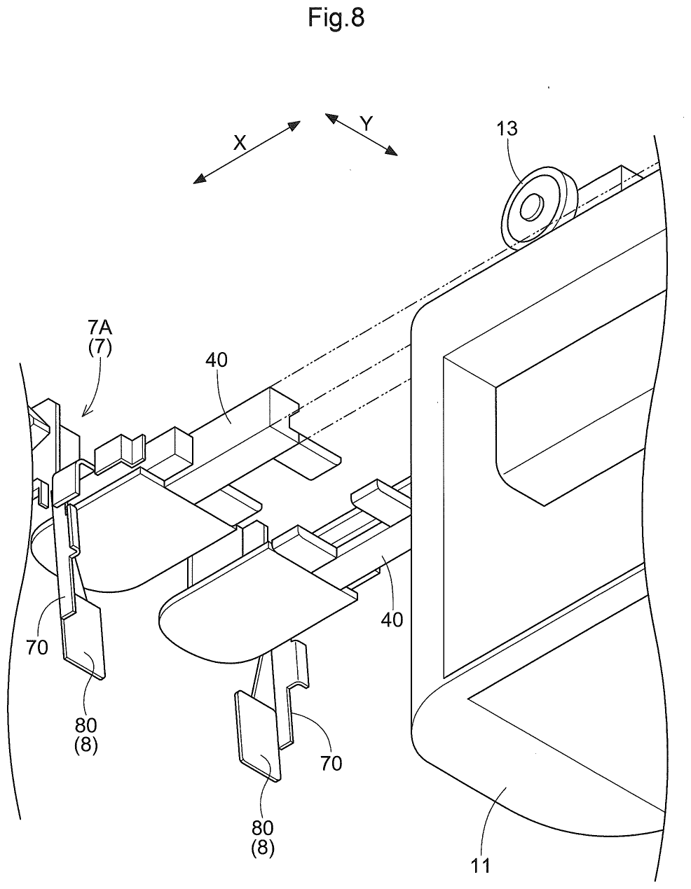

As shown in FIGS. 6 to 8, in the first restrictors 7A, the detection targets 8 may be disposed on the first extensions 62 in the movable rails 6 or on the swing members 70. In the present embodiment, the detection targets 8 are disposed on the swing members 70. The detection targets 8 are reflective plates 80 detectable by the obstacle sensor 14A (optical sensor) in the transport vehicle 1.

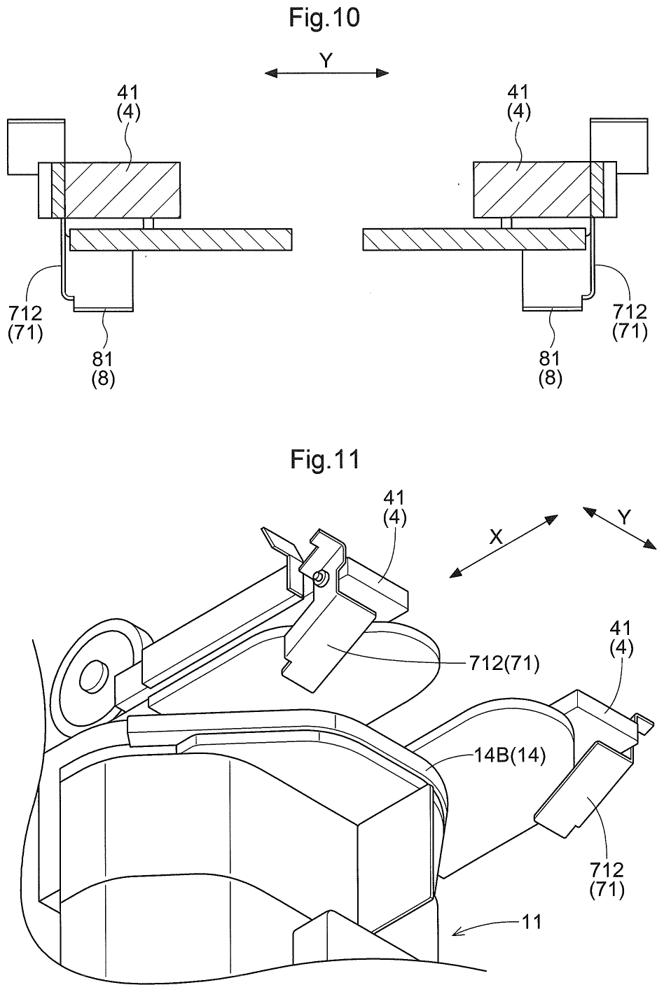

As shown in FIGS. 9 to 11, in the second restrictors 7B, the detection targets 8 may be disposed on the second extensions 712 in the support members 71. In the present embodiment, the detection targets 8 are disposed on the second extensions 712 in the support members 71. The detection targets 8 are contact members 81 detectable by the collision sensor 14B (bumper switch) in the transport vehicle 1. The contact members 81 are disposed to overlap the movement path of the collision sensor 14B in the transport vehicle 1.

The types and locations of the detection targets 8 are not limited to the above example, and may be changed, for example, as appropriate for the types of the sensors 14 in the transport vehicle 1. For example, the contact members 81 may be disposed on the swing members 70 in the first restrictors 7A. When the first restrictors 7A include no swing member 70, or in other words, when the movable rails 6 are to serve as the first restrictors 7A, for example, the detection targets 8, such as the reflective plates 80 or the contact members 81, may be disposed on the first extensions 62 in the movable rails 6. The second restrictors 7B may each include a reflective plate 80 attached to the second extension 712 in the support member 71 as a detection target 8. When the second restrictors 7B each include a swing member 70, for example, the detection target 8, such as the reflective plate 80 or the contact member 81, may be attached to the swing member 70.

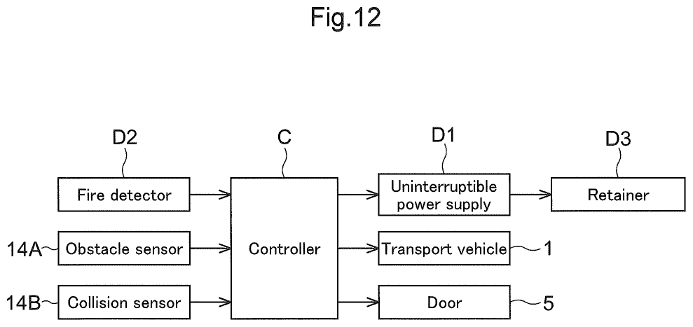

The rails 4 include an urging assembly (e.g., an assembly with a spring using its urging force) not shown that urges the rail connectors 61 to swing upward relative to the first fixed rails 40 about the first rotation axis when the movable rails 6 are in the connected orientation, and a retainer D3 (refer to FIG. 12) that switches between a retention mode in which the movable rails 6 are retained in the connected orientation and a release mode in which the retention of the movable rails 6 are released.

The retainer D3 is in the retention mode when energized with supply of power. The retainer D3 is in the release mode when non-energized with no supply of power. More specifically, placing the retainer D3 into the release mode swings the rail connectors 61 upward relative to the first fixed rails 40 about the first rotation axis to shift the movable rails 6 from the connected orientation to the retracted orientation. Examples of the retainer D3 include an assembly using a motor, an assembly using an electromagnetic lock, and an assembly using an electromagnet for retention.

In this structure, when the retainer D3 is non-energized with no supply of power, the retainer D3 enters the release mode, and the movable rails 6 are shifted to the retracted orientation by the urging assembly. Thus, the movable rails 6 are shifted from the connected orientation to the retracted orientation as appropriate in response to, for example, a power outage caused by fire. Thus, the movable rails 6 do not obstruct the opening or closing operation of the door 5.

As shown in FIG. 12, the transport facility 100 includes a fire detector D2 for detecting fire, a controller C, and an uninterruptible power supply D1. The controller C controls the operations of the uninterruptible power supply D1, the transport vehicle 1, and the door 5.

Upon input of fire information from the fire detector D2, the controller C outputs a power stop command to the uninterruptible power supply D1. In response to the power stop command, the uninterruptible power supply D1 stops supplying power to the retainer D3 to release the retainer D3, thus shifting the movable rails 6 from the connected orientation to the retracted orientation.

As shown in FIGS. 2 to 5, in response the movable rails 6 shifting from the connected orientation to the retracted orientation, the first restrictors 7A and the second restrictors 7B shift from the normal orientation in which the first restrictors 7A and the second restrictors 7B have no overlap with the transport vehicle path that is the movement path of the transport vehicle 1 to the protruding orientation in which the first restrictors 7A and the second restrictors 7B protrude to the positions overlapping the transport vehicle path.

In the present embodiment, for the first restrictors 7A, when the rail connectors 61 in the movable rails 6 swing upward relative to the first fixed rails 40 to be upright, the first extensions 62 in the movable rails 6 swing downward relative to the first fixed rails 40. When the first extensions 62 swing downward, the swing members 70 are released and swing downward under their weight. The second extensions 712 in the support members 71 in the second restrictors 7B also swing downward relative to the second fixed rails 41.

In the transport facility 100 during forward travel of the transport vehicle 1 as shown in FIG. 6, the controller C stops the travel of the transport vehicle 1 when the obstacle sensor 14A on the body of the transport vehicle 1 detects the reflective plates 80 on the swing members 70 in the first restrictors 7A and a detection signal is input into the controller C. During backward travel of the transport vehicle 1 as shown in FIG. 9, the controller C stops the travel of the transport vehicle 1 when the collision sensor 14B on the body of the transport vehicle 1 comes in contact with the contact members 81 on the second extensions 712 in the support members 71 in the second restrictors 7B and a contact signal is input into the controller C. The controller C then operates the door 5 (fire door) to close the opening 3 in the wall 2.

### 2. Other Embodiments

(1) As shown in FIG. 13, a step sensor S1 may be disposed adjacent to the first fixed rails 40 and a detection target member M may be disposed adjacent to the second fixed rails 41 to measure the dimension (or a distance in the path direction X) of a step between the first fixed rails 40 and the second fixed rails 41. In the present embodiment, the step sensor S1 is disposed on the hanging member h adjacent to the first fixed rails 40, and the detection target member M is disposed on at least one of the support members 71. The step sensor S1 may be, for example, a known laser gauge, and the detection target member M may be, for example, a reflective plate. This structure allows, for example, the controller C to issue an alert to a manager or cause the transport vehicle 1 to pass the movable rails 6 at a lower speed when the step between the first fixed rails 40 and the second fixed rails 41 exceeds a predetermined dimension.

(2) As shown in FIG. 13, the movable rails 6 may include, near the first shaft supports 60, a connection sensor S2 for detecting the movable rails 6 in the connected orientation, and a retraction sensor S3 for detecting the movable rails 6 in the retracted orientation. This structure with the connection sensor S2 can more reliably detect the movable rails 6 at their lowermost position, or in other words, the first fixed rails 40 and the second fixed rails 41 being connected. The structure with the retraction sensor S3 can more reliably detect the movable rails 6 at their uppermost position, or in other words, the first fixed rails 40 and the second fixed rails 41 being disconnected. This allows the controller C (refer to FIG. 12) to more smoothly and reliably perform an operation such as lowering the door 5 or stopping the transport vehicle 1 upon detection by the retraction sensor S3, or allowing the transport vehicle 1 to travel upon detection by the connection sensor S2. A single sensor may serve as the connection sensor S2 and the retraction sensor S3. For example, a single sensor that detects the rotation angle of the movable rails 6 may be used to detect the connected orientation and the retracted orientation.

The structure described in each of the above embodiments, other structures described as optional, and the structures described in the other embodiments may be combined as appropriate in any manner unless any contradiction arises. The embodiments described herein are merely illustrative in all aspects. Thus, the embodiments described herein may be modified variously as appropriate without departing from the spirit and scope of the disclosure.

### 3. Overview of Present Embodiment

An overview of the transport facility according to the embodiments described above is provided below.

A transport facility includes a rail, a door, and a restrictor. The rail is a rail on which a transport vehicle travels, the rail extending along a travel path of the transport vehicle in a path direction through an opening in a wall. The door opens and closes the opening. The rail includes a movable rail, a first fixed rail, and a second fixed rail. The movable rail is disposed in an overlapping area overlapping a door path that is a movement path of the door in opening and closing the opening. The first fixed rail is disposed on a first side in a path direction relative to the overlapping area. The second fixed rail is disposed on a second side in the path direction relative to the overlapping area. The first side and the second side in the path direction are opposite sides in the path direction. The movable rail is shiftable between a connected orientation, in which the movable rail is disposed in the overlapping area to connect the first fixed rail to the second fixed rail, and a retracted orientation, in which the movable rail is disposed outside of the overlapping area to disconnect the first fixed rail from the second fixed rail. The restrictor is to be in a normal orientation with the movable rail in the connected orientation, in which normal orientation the restrictor does not overlap with a transport vehicle path that is a movement path of the transport vehicle. The restrictor is to shift to a protruding orientation in response to the movable rail being shifted from the connected orientation to the retracted orientation, in which protruding orientation the restrictor protrudes to a position overlapping the transport vehicle path to restrict travel of the transport vehicle.

In this structure, the movable rail is shiftable from the connected orientation to the retracted orientation to prevent the rail from obstructing the opening or closing operation of the door. When the movable rail is in the connected orientation, the first fixed rail and the second fixed rail are connected by the movable rail. This reduces steps and gaps between the rails in the overlapping area, and thus reduces vibrations in the transport vehicle passing through the overlapping area.

The structure includes the restrictor that protrudes to the position overlapping the transport vehicle path in response to the movable rail shifting to the retracted orientation and restricts the travel of the transport vehicle. The structure thus appropriately restricts the transport vehicle from entering a disconnected section when the first fixed rail and the second fixed rail are disconnected by the movable rail.

In this structure, the restrictor shifts to the protruding orientation in response to the movable rail shifting from the connected orientation to the retracted orientation. Thus, a dedicated drive source for shifting the restrictor orientation is less likely to be used. The structure of the restrictor can thus be simplified easily to reduce costs.

The restrictor may be shiftable from the protruding orientation to the normal orientation in response to the movable rail shifting from the retracted orientation to the connected orientation.

In this structure, the restrictor shifts to the protruding orientation in response to the movable rail shifting from the connected orientation to the retracted orientation. This may reduce the workload of an operator for, for example, restoring the restrictor from the protruding orientation to the normal orientation.

The restrictor may include a detection target as at least one of a part detectable by an obstacle sensor included in the transport vehicle or a part to be in contact with a collision sensor included in the transport vehicle in the protruding orientation.

This structure appropriately restricts entry of a transport vehicle into the disconnected section without damaging the transport vehicle when the first fixed rail and the second fixed rail are disconnected by the movable rail.

The transport vehicle may include a traveler that travels on an upper surface of the rail, and a body hung from the traveler to travel below the rail. The movable rail may include a first shaft support supported on the first fixed rail in a manner swingable about a first rotation axis extending in a width direction perpendicular to the path direction when viewed in a vertical direction, a rail connector configured to connect the first fixed rail to the second fixed rail in the connected orientation, and a first extension extending toward the first side in the path direction relative to the first shaft support in the connected orientation. In response to the movable rail shifting from the connected orientation to the retracted orientation, the rail connector may swing upward about the first rotation axis relative to the first fixed rail and the first extension may swing downward about the first rotation axis relative to the first fixed rail. The detection target may be disposed on the first extension or on a member movable downward in response to downward movement of the first extension.

In this structure, when the movable rail shifts to the retracted orientation, the rail connector swings upward to be disposed upward relative to the first fixed rail, allowing the rail connector to serve as a stopper against the traveler of the transport vehicle. Thus, the transport vehicle is stopped more reliably when the movable rail is in the retracted orientation.

In this structure, the detection target in the restrictor may also protrude downward relative to the first fixed rail in response to such swing of the movable rail. A dedicated drive source is thus not used to shift the restrictor orientation. This easily simplifies the structure of the restrictor to reduce costs.

The transport vehicle may include a traveler that travels on an upper surface of the rail, and a body hung from the traveler to travel below the rail. The movable rail may include a first shaft support supported on the first fixed rail in a manner swingable about a first rotation axis extending in a width direction perpendicular to the path direction when viewed in a vertical direction, and a rail connector configured to connect the first fixed rail to the second fixed rail in the connected orientation. The rail may further include a support member. The support member may include a second shaft support supported on the second fixed rail in a manner swingable about a second rotation axis extending in the width direction, a support supporting, from below, an end of the rail connector on the second side in the path direction, with the movable rail in the connected orientation, and a second extension extending toward the second side in the path direction relative to the second shaft support with the movable rail in the connected orientation. In response to the movable rail shifting from the connected orientation to the retracted orientation, the rail connector may swing upward about the first rotation axis relative to the first fixed rail and the end of the rail connector on the second side in the path direction may move away from the support to cause the support member to swing about the second rotation axis toward such a side as to move the second extension downward relative to the second fixed rail. The detection target may be disposed on the second extension or on a member movable downward in response to downward movement of the second extension.

In this structure, when the movable rail shifts to the retracted orientation, the rail connector swings upward to be disposed up42ward relative to the first fixed rail, allowing the rail connector to serve as a stopper against the traveler of the transport vehicle. Thus, the transport vehicle is stopped more reliably when the movable rail is in the retracted orientation.

In this structure, the detection target in the restrictor may also protrude downward relative to the second fixed rail in response to such swing of the movable rail. A dedicated drive source is thus not used to shift the restrictor orientation. This easily simplifies the structure of the restrictor to reduce costs.

### INDUSTRIAL APPLICABILITY

The technique according to one or more embodiments of the disclosure is applicable to a transport facility including rails disposed along a travel path of transport vehicles extending through an opening in a wall and a door to open and close the opening.

What is claimed is:

1. A transport facility, comprising:
a rail on which a transport vehicle travels, the rail extending along a travel path of the transport vehicle in a path direction through an opening in a wall;
a door configured to open and close the opening,
wherein the rail comprises:
a movable rail disposed in an overlapping area overlapping with a door path as a movement path of the door to open and close the opening,
a first fixed rail disposed on a first side in the path direction relative to the overlapping area, and
a second fixed rail disposed on a second side in the path direction relative to the overlapping area, the first side and the second side in the path direction being opposite sides in the path direction,
wherein the movable rail is shiftable between a connected orientation in which the movable rail is disposed in the overlapping area to connect the first fixed rail to the second fixed rail, and a retracted orientation in which the movable rail is disposed outside of the overlapping area to disconnect the first fixed rail from the second fixed rail; and
a restrictor configured to be in a normal orientation with the movable rail in the connected orientation, wherein normal orientation the restrictor does not overlap with a transport vehicle path that is a movement path of the transport vehicle, and to shift to a protruding orientation in response to the movable rail being shifted from the connected orientation to the retracted orientation, and wherein protruding orientation the restrictor protrudes to a position overlapping the transport vehicle path to restrict travel of the transport vehicle.

2. The transport facility according to claim 1, wherein:
the restrictor is shiftable from the protruding orientation to the normal orientation in response to the movable rail shifting from the retracted orientation to the connected orientation.

3. The transport facility according to claim 1, wherein:
the restrictor comprises a detection target as at least one of a part detectable by an obstacle sensor included in the transport vehicle or a part to be in contact with a collision sensor included in the transport vehicle in the protruding orientation.

4. The transport facility according to claim 3, wherein:
the transport vehicle comprises a traveler configured to travel on an upper surface of the rail, and a body hung from the traveler and configured to travel below the rail,
the movable rail comprises:
a first shaft support supported on the first fixed rail in a manner swingable about a first rotation axis extending in a width direction perpendicular to the path direction when viewed in a vertical direction,
a rail connector configured to connect the first fixed rail to the second fixed rail in the connected orientation, and
a first extension extending toward the first side in the path direction relative to the first shaft support in the connected orientation,
in response to the movable rail shifting from the connected orientation to the retracted orientation, the rail connector swings upward about the first rotation axis relative to the first fixed rail, and the first extension swings downward about the first rotation axis relative to the first fixed rail, and
the detection target is disposed on the first extension or on a member movable downward in response to downward movement of the first extension.

5. The transport facility according to claim 3, wherein:
the transport vehicle comprises a traveler configured to travel on an upper surface of the rail, and a body hung from the traveler and configured to travel below the rail,
the movable rail comprises:
a first shaft support supported on the first fixed rail in a manner swingable about a first rotation axis extending in a width direction perpendicular to the path direction when viewed in a vertical direction, and
a rail connector configured to connect the first fixed rail to the second fixed rail in the connected orientation,
the rail further comprises a support member comprising:
a second shaft support supported on the second fixed rail in a manner swingable about a second rotation axis extending in the width direction,
a support supporting, from below, an end of the rail connector on the second side in the path direction with the movable rail in the connected orientation, and
a second extension extending toward the second side in the path direction relative to the second shaft support with the movable rail in the connected orientation,
in response to the movable rail shifting from the connected orientation to the retracted orientation, the rail connector swings upward about the first rotation axis relative to the first fixed rail, and the end of the rail connector on the second side in the path direction moves away from the support to cause the support member to swing about the second rotation axis toward such a side as to move the second extension downward relative to the second fixed rail, and
the detection target is disposed on the second extension or on a member movable downward in response to downward movement of the second extension.
